(19) United States
(12) Patent Application Publication
(10) Pub. No.: US 2014/0356778 A1
(43) Pub. Date: Dec. 4, 2014

(54) Toner Comprising Surface Modified Colorant

(71) Applicant: Xerox Corporation, Norwalk, CT (US)

(72) Inventors: Christopher Wolfe, Rochester, NY (US); Jay L. Schneider, Canandaigua, NY (US); Randy Pheav Tin, Webster, NY (US); Chieh-Min Cheng, Rochester, NY (US)

(73) Assignee: Xerox Corporation, Norwalk, CT (US)

(21) Appl. No.: 13/904,978

(22) Filed: May 29, 2013

(51) Int. Cl. G03G 9/09

(52) U.S. Cl. CPC G03G 9/092
USPC 430/108.21; 430/137.14; 430/137.11; 546/56

(57) ABSTRACT

A toner including a resin; an optional wax; and a colorant; wherein the colorant has disposed thereon a reactive component having at least one cross-linkable carbon-carbon double bond and wherein the tribo electric charge of the toner is adjusted through surface treatment of the colorant with the reactive component. Also a colorant having disposed thereon a reactive component having at least one cross-linkable carbon-carbon double bond, wherein the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof.

### BACKGROUND

Disclosed herein is a surface modified colorant comprising a colorant having disposed thereon a reactive component having at least one cross-linkable carbon-carbon double bond. Further disclosed is a toner comprising a resin, an optional wax, and a colorant, wherein the colorant has disposed thereon a reactive component having at least one cross-linkable carbon-carbon double bond and wherein the tribo electric charge of the toner is adjusted through surface treatment of the colorant with the reactive component.

Numerous processes are within the purview of those skilled in the art for the preparation of toners. Emulsion aggregation (EA) is one such method. These toners are within the purview of those skilled in the art and toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety.

Toner systems normally fall into two classes: two component systems, in which the developer material includes magnetic carrier granules having toner particles adhering tribo electrically thereto; and single component systems (SDC), which may use only toner. Placing charge on the particles, to enable movement and development of images via electric fields, is most often accomplished with tribo electricity. Tribo electric charging may occur either by mixing the toner with larger carrier beads in a two component development system or by rubbing the toner between a blade and donor roll in a single component system.

Polyester emulsion aggregation magenta toners can be prepared using a combination of PR122 and PR269 magenta pigments to achieve a desired toner color. Certain pigments used in emulsion aggregation toner can pose difficulties in particle aggregation capability and tribo electric charging characteristics.

Toner charging can be influenced by numerous factors in the aggregation/coalescence and downstream processes, such as raw material particle size, material chemical structure, ion concentration, coarse and fines generation, and toner washing. Currently, the most effective method of adjusting toner charge is altering the amount of water used to wash the particle during the dynamic washing stage. However, excessive reduction of wash water can adversely affect the toner quality regarding residual surfactant and ion amount. Methods to adjust toner tribo electric charge involving particle formulation changes or additive amount adjustments can be used, but are technically difficult to implement for toner domestication programs.

Chemical emulsion aggregation toners can show an increase in toner tribo electric charge upon aging in the machine which can result in the overall loss of development as well as an increase in color instability. This increase in tribo electric charge through toner aging is primarily due to the large difference between the parent particle of toner and final toner with additives blended onto the parent particle surface. While high toner aging is occurring (for example, running at less than 3% area coverage for an extended period of time), the toner is churning in the development housing where the additives on the surface of the toner are pounded into the surface of the toner exposing portions of the particle surface thereby increasing the overall toner tribo electric charge.

Currently available toners and toner processes are suitable for their intended purposes. However a need remains for improved toners and toner processes including improved methods for producing toner, which decrease the production time and permit excellent control of the charging of toner particles. Further, a need remains for improved toners and toner processes that provide lower machine tribo electric charging, improved image quality across a range of temperature and humidity conditions and toner aging.

The appropriate components and process aspects of the each of the foregoing U.S. patents and patent Publications may be selected for the present disclosure in embodiments thereof. Further, throughout this application, various publications, patents, and published patent applications are referred to by an identifying citation. The disclosures of the publications, patents, and published patent applications referenced in this application are hereby incorporated by reference into the present disclosure to more fully describe the state of the art to which this invention pertains.

### SUMMARY

Described is a toner comprising a resin; an optional wax; and a colorant; wherein the colorant has disposed thereon a reactive component having at least one cross-linkable carbon-carbon double bond and wherein the tribo electric charge of the toner is adjusted through surface treatment of the colorant with the reactive component.

Also described is a toner process comprising contacting a latex polymer; an optional wax; and a colorant to form a blend; wherein the colorant has disposed thereon a reactive component having at least one cross-linkable carbon-carbon double bond; adjusting the tribo electric charge of the toner through surface treatment of the colorant with the reactive component; heating the blend at a temperature below the glass transition temperature of the latex polymer to form aggregated toner particles; adding a coalescing agent to the toner particles thereby coalescing the toner particles; and recovering the toner particles.

Also described is a colorant having disposed thereon a reactive component having at least one cross-linkable carbon-carbon double bond, wherein the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof.

Also described is a colorant process comprising providing a colorant; disposing a reactive component having at least one cross-linkable carbon-carbon double bond on the colorant; optionally, stirring; and treating to effect cross-linking of the reactive component.

### BRIEF DESCRIPTION OF THE DRAWINGS

FIG. 1 is a graph showing particle size and size distribution for a surface-treated colorant in accordance with the present disclosure.

FIG. 2 is a bar graph showing color stability for a surface-treated colorant present disclosure and a comparative colorant.

FIG. 3 is a graph showing AT, (a normalized version of tribo electric charge, y-axis) versus ZTP run time (minutes, x-axis) for toner containing surface-treated colorants of the present disclosure and comparative toner.

### DETAILED DESCRIPTION

The present disclosure provides a toner comprising a resin; an optional wax; and a colorant; wherein the colorant has disposed thereon a reactive component having at least one cross-linkable carbon-carbon double bond and wherein the tribo electric charge of the toner can be adjusted through the surface treatment of the colorant with the reactive component.

The present disclosure further provides a colorant having disposed thereon a reactive component having at least one cross-linkable carbon-carbon double bond, wherein the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof.

In embodiments, a colorant, in certain embodiments a magenta PR122 pigment, is provided having a novel chemical preparation wherein the surface of the pigment particle is treated by disposing thereon a reactive resin or resins having cross-linkable carbon-carbon double bonds. The resin can be coated on the pigment particle surface, and then treated to effect cross-linking.

Treating to effect cross-linking of the reactive component can be by any suitable or desired treatment. In embodiments, treating comprises irradiating with visible light, irradiating with ultra-violet light, heating, or a combination thereof.

In embodiments, the reactive resin comprises bisphenol A glycerolate diacrylate. Following the resinate treatment, the modified pigment can be easily dispersed in an aqueous solution providing a stable pigment dispersion.

The colorant herein enables preparation of an emulsion aggregation toner, in embodiments, magenta emulsion aggregation toner, that can run in the machine at lower tribo electric charge, thus resulting in improved image quality across a range of temperature/humidity conditions and toner ages. By adjusting the tribo electric charge through surface treatment of the colorant, potential underwashing of the particle can be avoided and the nominal formulation of the toner can be maintained.

Resin.

Any suitable or desired resin can be used in the processes herein. In embodiments, the toner resin can be an amorphous resin, a crystalline resin, or a mixture or combination thereof. In further embodiments, the resin can be a polyester resin, including the resins described in U.S. Pat. No. 6,593,049 and U.S. Pat. No. 6,756,176, which are each hereby incorporated by reference herein in their entireties. Suitable resins can also include a mixture of an amorphous polyester resin and a crystalline polyester resin as described in U.S. Pat. No. 6,830,860, which is hereby incorporated by reference herein in its entirety.

In embodiments, the resin is polyester. In certain embodiments, the resin is amorphous polyester, crystalline polyester, or a mixture thereof.

For forming a crystalline polyester, one or more polyol branching monomers can be reacted with a diacid in the presence of an optional catalyst and a further organic diol suitable for forming the crystalline resin including aliphatic diols having from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol, and mixtures and combinations thereof, including their structural isomers. The aliphatic diol may be present in any suitable or desired amount, such as from about 25 to about 60 mole percent, or from about 25 to about 55 mole percent, or from about 25 to about 53 mole percent of the resin. In embodiments, a third diol can be selected from the above-described diols in an amount of from about 0 to about 25 mole percent, or from about 1 to about 10 mole percent of the resin.

Examples of organic diacids or diesters including vinyl diacids or vinyl diesters that can be selected for the preparation of the crystalline resin include oxalic acid, succinic acid, glutaric acid, adipic acid, suberic acid, azelaic acid, sebacic acid, fumaric acid, dimethyl fumarate, dimethyl itaconate, cis-1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid, mesaconic acid, a diester or anhydride thereof, and mixtures and combinations thereof. The organic diacid can be present in any suitable or desired amount, in embodiments, from about 25 to about 60 mole percent, or from about 25 to about 52 mole percent, or from about 25 to about 50 mole percent. In embodiments, a second diacid can be selected from the above-described diacids and can be present in an amount of from about 0 to about 25 mole percent of the resin.

For forming crystalline polyester, one or more polyacid branching monomers can be reacted with a diol in the presence of an optional catalyst and a further organic diacid or diester. The components can be selected in any suitable or desired ratio. In embodiments, the branching monomer can be provided in an amount of from about 0.1 to about 15 mole percent, or from about 1 to about 10 mole percent, or from about 2 to about 5 mole percent, and, in embodiments, a second branching monomer can be selected in any suitable or desired amount, in embodiments, from about 0 to about 10 mole percent, or from about 0.1 to about 10 mole percent of the robust resin.

Examples of diacids or diesters suitable for use in forming the resin herein include vinyl diacids or vinyl diesters used for the preparation of amorphous polyester resins including dicarboxylic acids or diesters such as terephthalic acid, phthalic acid, isophthalic acid, fumaric acid, trimellitic acid, dimethyl fumarate, dimethyl itaconate, cis-1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, lutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethladipate, dimethyl dodecylsuccinate, and mixtures and combinations thereof.

The organic diacid or diester may be present in any suitable or desired amount, such as from about 35 to about 60 mole percent of the resin, or from about 42 to about 52 mole percent of the resin, or from about 45 to about 50 mole percent of the resin.

Examples of diols which may be used to prepared the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cycloheaxanediol, diethylene glycol, bis(2-hydroxyethyl)oxide, dipropylene glycol, dibutylene, and mixtures and combinations thereof.

The organic diol can be present in any suitable or desired amount, such as from about 35 to about 60 mole percent of the resin, or from about 42 to about 55 mole percent of the resin, or from about 45 to about 53 mole percent of the resin.

In embodiments, polycondensation catalysts may be used in forming the polyesters. Polycondensation catalysts which may be utilized for either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, and mixtures and combinations thereof. Such catalysts may be utilized in any suitable or desired amount, such as from about 0.01 mole percent to about 5 mole percent based on the starting diacid or diester used to generate the polyester resin.

The resin can be prepared by any suitable or desired method. For example, one or more monomers can be combined with one or more acid or diester components in the optional presence of a catalyst, heated, optionally in an inert atmosphere, to condense the monomers into prepolymers. To this mixture can be added one or more diacids or diesters, optionally additional catalyst, optionally a radical inhibitor, with heating, optionally under inert atmosphere, to form the desired final resin (polyester).

Heating can be to any suitable or desired temperature, such as from about 140° C. to about 250° C., or about 160° C. to about 230° C., or about 180° C. to about 220° C.

Any suitable inert atmosphere conditions can be selected, such as under nitrogen purge.

If desired, a radical inhibitor can be used. Any suitable or desired radical inhibitor can be selected, such as hydroquinone, toluhydroquinone, 2,5-DI-tert-butylhydroquinone, and mixtures and combinations thereof. The radical inhibitor can be present in any suitable or desire amount, such as from about 0.01 to about 1.0, about 0.02 to about 0.5, or from about 0.05 to about 0.2 weight percent of the total reactor charge.

In embodiments, the resin can be pre-blended with a weak base or neutralizing agent. In embodiments, the base can be a solid, thereby eliminating the need to use a solution, which avoids the risks and difficulties associated with pumping a solution.

In embodiments, the resin and the neutralizing agent can be simultaneously fed through a co-feeding process which may accurately control the feed rate of the neutralizing agent and the resin into an extruder and which may then be melt mixed followed by emulsification.

In embodiments, the neutralizing agent can be used to neutralize acid groups in the resins. Any suitable or desired neutralizing agent can be selected. In embodiments, the neutralizing agent can be selected from the group consisting of ammonium hydroxide, potassium hydroxide, sodium hydroxide, sodium carbonate, sodium bicarbonate, lithium hydroxide, potassium carbonate, and mixtures and combinations thereof.

The neutralizing agent can be used as a solid, such as sodium hydroxide flakes, etc., in an amount of from about 0.001% to about 50% by weight, or from about 0.01% to about 25% by weight, or from about 0.1% to about 5% by weight, based on the weight of the resin.

In certain embodiments, the neutralizing agent is a solid neutralizing agent selected from the group consisting of ammonium hydroxide flakes, potassium hydroxide flakes, sodium hydroxide flakes, sodium carbonate flakes, sodium bicarbonate flakes, lithium hydroxide flakes, potassium carbonate flakes, organoamines, and mixtures and combinations thereof.

In embodiments, the neutralizing agent can be sodium hydroxide flakes. In embodiments, the surfactant used can be an aqueous solution of alkyldiphenyloxide disulfonate to ensure that proper resin neutralization occurs when using sodium hydroxide flakes and leads to a high quality latex with low coarse content. Alternatively, a solid surfactant of sodium dodecyl benzene sulfonate can be used and co-fed with the resin into the extruder feed hopper eliminating the need to use a surfactant solution thereby providing a simplified and efficient process.

An emulsion formed in accordance with the present process can also include a small amount of water, in embodiments, deionized water, in any suitable or desired amount, such as from about 20% to about 300%, or from about 30% to about 150%, by weight of the resin, at temperatures that melt or soften the resin, such as from about 40° C. to about 140° C., or from about 60° C. to about 100° C.

Further, any other monomer suitable for preparing a latex for use in a toner may be utilized as the resin. As noted above, in embodiments, the toner may be produced by emulsion aggregation. Suitable monomers useful in forming a latex polymer emulsion, and thus the resulting latex particles in the latex emulsion, include, but are not limited to, styrenes, acrylates, methacrylates, butadienes, isoprenes, acrylic acids, methacrylic acids, acrylonitriles, combinations thereof, and the like.

In embodiments, the latex polymer may include at least one polymer. Exemplary polymers include styrene acrylates, styrene butadienes, styrene methacrylates, and more specifically, poly(styrene-alkyl acrylate), poly(styrene-1,3-diene), poly(styrene-alkyl methacrylate), poly (styrene-alkyl acrylate-acrylic acid), poly(styrene-1,3-diene-acrylic acid), poly (styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly (styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly (styrene-butadiene-acrylic acid), poly(styrene-butadiene-methacrylic acid), poly (styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and combinations thereof. The polymers may be block, random, or alternating copolymers.

In embodiments, the resin is selected from the group consisting of styrenes, acrylates, methacrylates, butadienes, isoprenes, acrylic acids, methacrylic acids, acrylonitriles, and combinations thereof.

In certain embodiments, the resin is selected from the group consisting of poly(styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylateisoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), poly(acrylonitrile-butyl acrylate-acrylic acid), and combinations thereof.

Surfactant.

In embodiments, the latex may be prepared in an aqueous phase containing a surfactant or co-surfactant. Surfactants which may be utilized with the polymer to form a latex dispersion can be ionic or nonionic surfactants, or combinations thereof, in an amount of from about 0.01 to about 15 weight percent of the solids, and in embodiments of from about 0.1 to about 10 weight percent of the solids.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abietic acid available from Aldrich, NEOGEN R™, NEOGEN SC™ obtained from Daiichi Kogyo Seiyaku Co., Ltd., combinations thereof, and the like.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C12, C15, C17 trimethyl ammonium bromides, combinations thereof, and the like. Other cationic surfactants include cetyl pyridinium bromide, halide salts of quaternized polyoxyethylalkylamines, dodecylbenzyl triethyl ammonium chloride, MIRAPOL® and ALKAQUAT® available from Alkaril Chemical Company, SANISOL (benzalkonium chloride), available from Kao Chemicals, combinations thereof, and the like. In embodiments a suitable cationic surfactant includes SANISOL® B-50 available from Kao Corp., which is primarily a benzyl dimethyl alkonium chloride.

Examples of nonionic surfactants include, but are not limited to, alcohols, acids and ethers, for example, polyvinyl alcohol, polyacrylic acid, methalose, methyl cellulose, ethyl cellulose, propyl cellulose, hydroxyl ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, combinations thereof, and the like. In embodiments commercially available surfactants from Rhone-Poulenc such as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™ can be utilized.

The choice of particular surfactants or combinations thereof, as well as the amounts of each to be used, are within the purview of those skilled in the art.

Initiators.

In embodiments initiators may be added for formation of the latex polymer. Examples of suitable initiators include water soluble initiators, such as ammonium persulfate, sodium persulfate and potassium persulfate, and organic soluble initiators including organic peroxides and azo compounds including Vazo peroxides, such as VAZO 64™, 2-methyl 2-2′-azobis propanenitrile, VAZO 88™, 2-2′-azobis isobutyramide dehydrate, and combinations thereof. Other water-soluble initiators which may be utilized include azoamidine compounds, for example 2,2′-azobis(2-methyl-N-phenylpropionamidine) dihydrochloride, 2,2′-azobis[N-(4-chlorophenyl)-2-methylpropionamidine]di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis{2-[1-(2-hydroxyethyl)-2-imidazolin-2-yl]propane}dihydrochloride, combinations thereof, and the like.

Initiators can be added in suitable amounts, such as from about 0.1 to about 8 weight percent of the monomers, and in embodiments of from about 0.2 to about 5 weight percent of the monomers.

Chain Transfer Agent.

In embodiments, chain transfer agents may also be utilized in forming the latex polymer. Suitable chain transfer agents include dodecane thiol, octane thiol, carbon tetrabromide, combinations thereof, and the like, in amounts from about 0.1 to about 10 percent and, in embodiments, from about 0.2 to about 5 percent by weight of monomers, to control the molecular weight properties of the latex polymer when emulsion polymerization is conducted in accordance with the present disclosure.

Additives.

In embodiments, the toner particles may further contain optional additives as desired or required. For example, the toner may include positive or negative charge control agents, such as in an amount of from about 0.1 to about 10%, or from about 1 to about 3% by weight of the toner. Examples of suitable charge control agents include quaternary ammonium compounds inclusive of alkyl pyridinium halides, bisulfates, alkyl pyridinium compounds, including those disclosed in U.S. Pat. No. 4,298,672, which is hereby incorporated by reference herein in its entirety, organic sulfate and sulfonate compositions, including those discloses in U.S. Pat. No. 4,338,390, which is hereby incorporated by reference herein in its entirety, cetyl pyridinium tetrafluoroborates, distearyl dimethyl ammonium methyl sulfate, aluminum salts such as CONTRON E84™ or E88™ (Orient Chemical Industries, Ltd.), and mixtures and combinations thereof.

There can also be blended with the toner particles external additive particles including flow aid additives, which additives may be present on the surface of the toner particles. Examples of these additives include metal oxides such as titanium oxide, silicon oxide, aluminum oxide, cerium oxide, tin oxide, mixtures thereof, and the like; colloidal and amorphous silicas, such as AEROSIL®, metal salts and metal salts of fatty acids inclusive of zinc stearate, calcium stearate, or long chain alcohols such as UNILIN® 700, and mixtures and combinations thereof.

Silica may be applied to the toner surface for toner flow, tribo enhancement, admix control, improved development and transfer stability, and higher toner blocking temperature. TiO₂ may be applied for improved relative humidity (RH) stability, tribo control, and improved development and transfer stability. Zinc stearate, calcium stearate and/or magnesium stearate may optionally also be used as an external additive for providing lubricating properties, developer conductivity tribo enhancement, enabling higher toner charge and charge stability by increasing the number of contacts between toner an carrier particles. In embodiments, a commercially available zinc stearate known as Zinc Stearate L, available from Ferro Corporation, may be used. The external surface additives may be used with or without a coating.

Each of these external additives may be present in any suitable or desired amount, such as from about 0.1 percent by weight to about 5 percent by weight of the toner, or from about 0.2 percent by weight to about 3 percent by weight of the toner.

The latex emulsion containing the resin or resins may be utilized to form a toner by any method within the purview of those skilled in the art. The latex emulsion may be contacted with a colorant, optionally in the form of a colorant dispersion, and other additives to form a toner by a suitable process, in embodiments, an emulsion aggregation and coalescence process. In embodiments, the toner processes herein employ the latex emulsions herein to produce particle sizes that are suitable for emulsion aggregation ultra low melt processes.

In embodiments, a toner process herein comprises providing an aqueous emulsion comprising a resin; an optional wax, and a colorant, wherein the colorant has disposed thereon a reactive component having at least one cross-linkable carbon-carbon double bond, and aggregating toner particles from the aqueous emulsion.

Optionally, the toner process further comprises coalescing the aggregated toner particles.

In embodiments, the toner process further comprises wherein the aggregated toner particles form a core, and further comprise, during aggregation, adding additional emulsion to form a shell over the core. In certain embodiments, the additional emulsion forming the shell is the same material as the emulsion forming the core. In other embodiments, the additional emulsion forming the shell can be different from the material forming the toner core.

In other embodiments, the toner herein can be formed by a process comprising homogenizing the resin emulsion with a surfactant, the colorant having the reactive component disposed thereon, an optional wax, and an optional coagulant to form a homogenized toner slurry comprising pre-aggregated particles at room temperature; heating the slurry to form aggregated toner particles; optionally freezing the toner slurry once at the desired aggregated particle size; and further heating the aggregated particles in the slurry to coalesce the aggregated particles into toner particles.

Heating to form aggregated toner particles may be to any suitable or desired temperature for any suitable or desired time. In embodiments heating to form aggregated toner particles may be to a temperature below the Tg of the latex, in embodiments to from about 30° C. to about 70° C. or to about 40° C. to about 65° C., for a period of time of from about 0.2 hour to about 6 hours, from about 0.3 hour to about 5 hours, in embodiments, resulting in toner aggregates of from about 3 microns to about 15 microns in volume average diameter, in embodiments of from about 4 microns to about 8 microns in volume average diameter, although not limited.

Freezing the toner slurry to stop particle growth once the desired aggregated particle size is achieved can be by any suitable or desired method. In embodiments, the mixture is cooled in a cooling or freezing step. In embodiments, the mixture is pH adjusted, such as by freezing the aggregation of the particles with a buffer solution having a pH of about 7 to about 12, over a period of from about 1 minute to about 1 hour, or to about 8 hours or from about 2 minutes to about 30 minutes. In embodiments, cooling a coalesced toner slurry includes quenching by adding a cooling medium such as, for example, ice, dry ice and the like, to effect rapid cooling to a temperature of from about 20° C. to about 40° C. or from about 22° C. to about 30° C.

Coalescing the aggregated particles into toner particles can be by any suitable or desired method. In embodiments, coalescing comprises further heating the aggregated particles in the slurry to coalesce the aggregated particles into toner particles. In embodiments, the aggregate suspension may be heated to a temperature at or above the Tg of the latex. Where the particles have a core-shell configuration, heating may be above the Tg of the first latex used to form the core and the Tg of the second latex used to form the shell, to fuse the shell latex with the core latex. In embodiments, the aggregate suspension may be heated to a temperature of from about 80° C. to about 120° C. or from about 85° C. to about 98° C., for a period of time from about 1 hour to about 6 hours or from about 2 hours to about 4 hours.

The toner slurry may then be washed. In embodiments, washing may be carried out at a pH of from about 7 to about 12 or from about 9 to about 11 and the washing may be at a temperature of from about 30° C. to about 70° C. or from about 40° C. to about 67° C. The washing may include filtering and reslurrying a filter cake including toner particles in deionized water. The filter cake may be washed one or more times by deionized water, or washed by a single deionized water wash at a pH of about 4 wherein the pH of the slurry is adjusted with an acid, and followed optionally by one or more deionized water washes.

In embodiments, drying may be carried out at a temperature of from about 35° C. to about 85° C. or from about 45° C. to about 60° C. The drying may be continued until the moisture level of the particles is below a set target of about 1% by weight, in embodiments of less than about 0.7% by weight.

pH Adjustment Agent.

In some embodiments a pH adjustment agent may be added to control the rate of the emulsion aggregation process. The pH adjustment agent utilized in the processes of the present disclosure can be any acid or base that does not adversely affect the products being produced. Suitable bases can include metal hydroxides, such as sodium hydroxide, potassium hydroxide, ammonium hydroxide, and optionally combinations thereof. Suitable acids include nitric acid, sulfuric acid, hydrochloric acid, citric acid, acetic acid, and optionally combinations thereof.

Wax.

Wax dispersions may also be added during formation of a latex polymer in an emulsion aggregation synthesis. Suitable waxes include, for example, submicron wax particles in the size range of from about 50 to about 1000 nanometers, in embodiments of from about 100 to about 500 nanometers in volume average diameter, suspended in an aqueous phase of water and an ionic surfactant, nonionic surfactant, or combinations thereof. Suitable surfactants include those described above. The ionic surfactant or nonionic surfactant may be present in an amount of from about 0.1 to about 20 percent by weight, and in embodiments of from about 0.5 to about 15 percent by weight of the wax.

The wax dispersion according to embodiments of the present disclosure may include, for example, a natural vegetable wax, natural animal wax, mineral wax, and/or synthetic wax. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes of the present disclosure include, for example, Fischer-Tropsch wax, acrylate wax, fatty acid amide wax, silicone wax, polytetrafluoroethylene wax, polyethylene wax, polypropylene wax, and combinations thereof.

Examples of polypropylene and polyethylene waxes include those commercially available from Allied Chemical and Baker Petrolite, wax emulsions available from Michelman Inc. and the Daniels Products Company, EPOLENE® N-15 commercially available from Eastman Chemical Products, Inc., VISCOL® 550-P, a low weight average molecular weight polypropylene available from Sanyo Kasel K.K., and similar materials. In embodiments, commercially available polyethylene waxes possess a molecular weight (Mw) of from about 100 to about 5000, and in embodiments of from about 250 to about 2500, while the commercially available polypropylene waxes have a molecular weight of from about 200 to about 10,000, and in embodiments of from about 400 to about 5000.

In embodiments, the waxes may be functionalized. Examples of groups added to functionalize waxes include amines, amides, imides, esters, quaternary amines, and/or carboxylic acids. In embodiments, the functionalized waxes may be acrylic polymer emulsions, for example, JONCRYL® 74, 89, 130, 537, and 538, all available from Johnson Diversey, Inc, or chlorinated polypropylenes and polyethylenes commercially available from Allied Chemical, Baker Petrolite Corporation and Johnson Diversey, Inc.

The wax may be present in any suitable or desired amount, such as an amount of from about 0.1 to about 30 percent by weight, and in embodiments from about 2 to about 20 percent by weight of the toner.

Colorants.

The present disclosure provides a colorant which has coated thereon a reactive component having at least one cross-linkable carbon-carbon double bond.

In embodiments, the colorant has disposed thereon a reactive component having at least one cross-linkable carbon-carbon double bond.

Any suitable or desired reactive component can be used in embodiments herein. In certain embodiments, the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof. In a specific embodiment, the reactive component disposed on the colorant is bisphenol A glycerolate diacrylate.

In embodiments, the colorant particles may be suspended in an aqueous water phase containing an anionic surfactant, a nonionic surfactant, or mixtures thereof. In embodiments, the surfactant may be ionic and may be present in an amount of from about 1 to about 25 percent, or from about 4 to about 15 percent, by weight of the colorant.

Any suitable or desired colorant can be selected in embodiments herein including various known suitable colorants, such as dyes, pigments, mixtures of dyes, mixtures of pigments, mixtures of dyes and pigments, and the like, which may be included in the toner or colorant dispersions herein.

In embodiments, the colorant can be, for example, carbon black, cyan, yellow, magenta, red, orange, brown, green, blue, violet, or mixtures thereof.

In certain embodiments, the colorant is selected from the group consisting of dyes, pigments, and combinations of dyes and pigments. As examples of suitable colorants, mention may be made of carbon black such as REGAL 330® (Cabot), Carbon Black 5250 and 5750 (Columbian Chemicals), Sunsperse® Carbon Black LHD 9303 (Sun Chemicals); magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE® 6000, FLEXIVERSE® and AQUATONE® water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM® YELLOW FGL™, HOSTAPERM® PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, Yellow 180, and Permanent Yellow FGL. Colored magnetites, such as mixtures of MAPICO BLACK™, and cyan components may also be selected as colorants. Other known colorants can be selected, such as Levanyl® Black A-SF (Miles, Bayer) and Sunsperse® Carbon Black LHD 9303 (Sun Chemicals), and colored dyes such as Neopen® Blue (BASF), Sudan Blue OS (BASF), PV Fast Blue B2G01 (American Hoechst), Sunsperse® Blue BHD 6000 (Sun Chemicals), Irgalite® Blue BCA (Ciba-Geigy), Paliogen® Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen® Orange 3040 (BASF), Ortho® Orange OR 2673 (Paul Uhlich), Paliogen® Yellow 152, 1560 (BASF), Lithol® Fast Yellow 0991K (BASF), Paliotol® Yellow 1840 (BASF), Neopen® Yellow (BASF), Novoperm® Yellow FG 1 (Hoechst), Permanent Yellow YE 0305 (Paul Uhlich), Lumogen® Yellow D0790 (BASF), Sunsperse® Yellow YHD 6001 (Sun Chemicals), Suco-Gelb® L1250 (BASF), Suco-Yellow® D1355 (BASF), Hostaperm® Pink E (American Hoechst), Fanal® Pink D4830 (BASF), Cinquasia® Magenta (DuPont), Lithol® Scarlet D3700 (BASF), Toluidine Red (Aldrich), Scarlet for Thermoplast NSD PS PA (Ugine Kuhlmann of Canada), E.D. Toluidine Red (Aldrich), Lithol® Rubine Toner (Paul Uhlich), Lithol® Scarlet 4440 (BASF), Bon Red C (Dominion Color Company), Royal® Brilliant Red RD-8192 (Paul Uhlich), Oracet® Pink RF (Ciba-Geigy), Paliogen® Red 3871K (BASF), Paliogen® Red 3340 (BASF), Lithol® Fast Scarlet L4300 (BASF), combinations of the foregoing, and the like.

In embodiments, organic soluble dyes having a high purity for the purpose of color gamut which may be utilized include Neopen Yellow 075, Neopen Yellow 159, Neopen Orange 252, Neopen Red 336, Neopen Red 335, Neopen Red 366, Neopen Blue 808, Neopen Black X53, and Neopen Black X55.

The dyes can be present in any suitable or desired amount, in embodiments, in an amount of from about 0.5 to about 20, or from about 5 to about 20 percent, by weight percent of the toner.

In certain embodiments wherein the colorant is a pigment, the pigment may be, for example, carbon black, phthalocyanines, quinacridones or RHODAMINE B™ type, red, green, orange, brown, violet, yellow, fluorescent colorants, and the like.

In embodiments, colorant examples include Pigment Blue 15:3 having a Color Index Constitution Number of 74160, Magenta Pigment Red 81:3 having a Color Index Constitution Number of 45160:3, Yellow 17 having a Color Index Constitution Number of 21105, and known dyes such as food dyes, yellow, blue, green, red, magenta dyes, and the like.

In other embodiments, a magenta pigment, Pigment Red 122 (2,9-dimethylquinacridone), Pigment Red 185, Pigment Red 192, Pigment Red 202, Pigment Red 206, Pigment Red 235, Pigment Red 269, and the like, and combinations thereof, may be utilized as the colorant.

In embodiments, the colorant is 2,9-Dimethylquinacridone. Due to its unique magenta shade, 2,9-Dimethylquinacridone can be used for the pigmentation of plastics, ink, toners and coatings. It is particularly useful as a shading component in combination with other pigments. PR122 also possesses excellent fastness to migration and outstanding heat stability. In embodiments, the colorant is PR122 of the formula

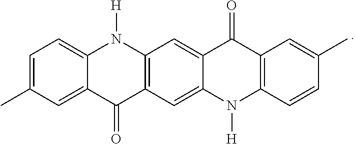

PR-122 has a rod-like molecular structure in the dense crystal clusters. This characteristic also leads to the poor dispersibility in aqueous phase and miscibility with other materials.

In embodiments, reactive components are disposed on the colorant herein, in certain embodiments, reactive components are disposed on amino groups in PR122. In embodiments, components comprising C═C—C═O double bonds can be reacted with the amino groups through electrophilic addition.

In embodiments, the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof.

In certain embodiments, the reactive component is bisphenol A glycerolate diacrylate of the formula

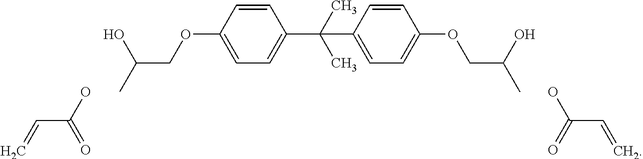

In the addition reaction, the acrylates could also undergo through self-polymerization to form crosslinked shell for PR-122 pigment particles, resulting in improved pigment dispersibility and miscibility with other EA materials. The mechanism for disposing the reactive component on the colorant can be as follows

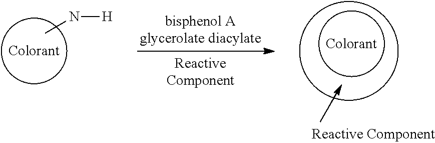

In embodiments, the colorant is a magenta pigment selected from the group consisting of Pigment Red 122, Pigment Red 185, Pigment Red 192, Pigment 202, Pigment Red 206, Pigment Red 235, Pigment Red 269, and combinations thereof.

In certain embodiments, the colorant is a magenta pigment selected from the group consisting of Pigment Red 122, Pigment Red 185, Pigment Red 192, Pigment 202, Pigment Red 206, Pigment Red 235, Pigment Red 269, and combinations thereof, and the reactive component disposed on the colorant is bisphenol A glycerolate diacrylate.

When used in a toner, the colorant may be included in the toner any suitable or desired amount, in embodiments, the colorant may be included in the toner in an amount of from about 0.1 to about 35 percent by weight of the toner, or from about 1 to about 25 weight percent of the toner, or from about 2 to about 15 percent by weight of the toner.

Developer compositions can be prepared by mixing the toners obtained with the processes disclosed herein with known carrier particles, including coated carriers, such as steel, ferrites, and the like. Such carriers include those disclosed in U.S. Pat. Nos. 4,937,166 and 4,935,326, the entire disclosures of each of which are incorporated herein by reference. The carriers may be present from about 2 percent by weight of the toner to about 8 percent by weight of the toner, in embodiments from about 4 percent by weight to about 6 percent by weight of the toner. The carrier particles can also include a core with a polymer coating thereover, such as polymethylmethacrylate (PMMA), having dispersed therein a conductive component like conductive carbon black. Carrier coatings include silicone resins such as methyl silsesquioxanes, fluoropolymers such as polyvinylidene fluoride, mixtures of resins not in close proximity in the tribo electric series such as polyvinylidene fluoride and acrylics, thermosetting resins such as acrylics, combinations thereof and other known components.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

X-Ray Photoelectron Spectroscopy (XPS). Top surface elemental composition is readily determined from energy positions of the peaks in a broad scan survey spectrum. Detailed chemical bonding information (e.g., oxidation states) is obtained from narrower, high resolution window region spectra. XPS is particularly useful when analyzing plastics, rubber compounds, and other samples easily damaged by alternate radiations. In addition, insulating materials that charge severely upon excitation by other sources can be readily examined with XPS. Photoreceptor surface contamination identification is performed routinely. Photoreceptor materials represent typical types of samples that are examined routinely.

Inductively Coupled Plasma Optical Emission Spectroscopy (ICP-OES). ICP Optical Emission Spectroscopy is a technique which can be utilized for both quantitative and qualitative elemental analysis of metal and non-metals. Sample preparation involves the dissolution of elements of interest in a matrix, preferentially aqueous, but some organics can be used. The high temperature of the plasma makes it relatively free from chemical interferences. Detection limits can be as low as 0.005 ppm depending on the elements and matrix.

Fluid Rheometry (FLUID). This technique consists of putting fluid in a narrow gap and shearing the fluid either by Couette flow either by steady rotation or by oscillatory deformation.

Bench Tribo. Tribo is a measurement of the average “charge to mass” or q/m ratio of tribo-electrically charged toners and carriers in units of microCoulombs/gram. A developer sample is placed in a stainless steel Faraday cage with screens small enough to retain the carrier, but not the toner. When placed inside a TC/Tribo fixture (a.k.a. Barbetta Box), an air jet separates the toner from the carrier and forces it out of the cage leaving just the carrier behind. The charge of the carrier is measured and assumed to be equal in magnitude and opposite in polarity to that of the toner removed. The measured charge and weight of the toner blown off are used to calculate toner tribo (q/m), toner concentration (TC), A_{T}, Tribo Product (a.k.a. carrier tribo), and other related parameters of interest.

Particle Size/Circularity. Volume average particle diameter and geometric standard deviation may be measured using an instrument, such as, a Beckman Coulter MULTISIZER 3, operated in accordance with the instructions of the manufacturer. Circularity can be measured with a Sysmex 3000 analyzer.

Particle sizes can also be obtained with a Nanotrac® Particle Size Analyzer (Microtrac Inc.) along with particle size distribution and standard deviation.

### Example 1

3 kilograms of PR122 magenta pigment powder (obtained from Sun Chemical) was dispersed in 11 kilograms of toluene. With stirring, 0.3 kilogram of bisphenol A glycerolate diacrylate [Bis-GDA, obtained from Sigma-Aldrich®] was added dropwise into the PR122 slurry. After being exposed to light and stirred at room temperature for one day, the slurry was filtered. The modified PR122 was dried at 65° C. under vacuum overnight.

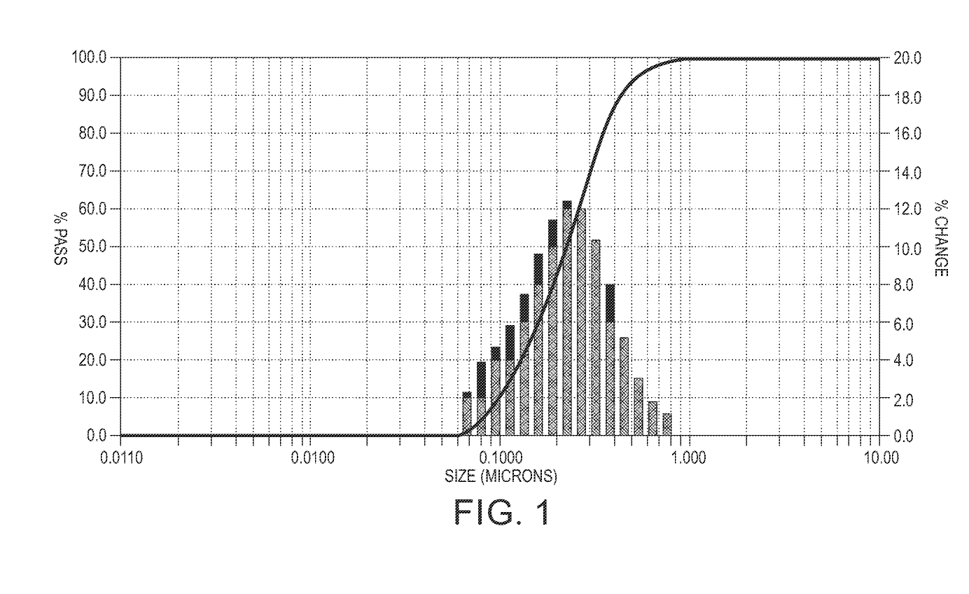

A mixture of 1.5 kilograms of modified PR122, 0.12 kilogram of TaycaPower® BN2060 branched sodium dodecyl sulfonates surfactant (obtained from Tayca Corporation), and 8.4 kilograms of deionized water was homogenized using a Cavitron® homogenizer at 2000 revolutions per minute (rpm) for 6 minutes to obtain a modified PR122 dispersion. This dispersion was very stable even without agitation. The particle size and size distribution of this dispersion was measured using a Microtrac Inc. Nanotrac particle size analyzer. The test sample was not filtered. After the simple dispersion process, the surface modified PR122 particle size was about 217 nanometers. The particle size and size distribution for the surface treated PR11 dispersion is shown in FIG. 1.

The surface modified pigment of Example 1 and a control pigment comprising un-modified PR122 magenta pigment powder (obtained from Sun Chemical) were subjected to particle size and circularity measurements, bench tribo electric charge measurements as well as surface XPS (X-ray photoelectron spectroscopy), particle ICP (inductively coupled plasma optical emission spectroscopy, ICP-OES), residual surfactant, and rheological analyses. Results are shown in Table 1.

TABLE 1

| | | | | Percent | | | | Viscosity | | | | |
|---|---|---|---|---|---|---|---|---|---|---|---|---|
| | | Surfactant | | Non- | W143 | W143 | Delta | (20 rpm, | Ca | Fe | P | Si |
| | | pph (on | | volatile | Nanotrac | Nanotrac | E | 25° C.) | (ppm) | (ppm) | (ppm) | (ppm) |
| Pigment | Surfactant | pigment) | pH | Solids | D50 (nm) | D95 (nm) | 2000 | cps | via ICP | via ICP | via ICP | via ICP |
| Example 1 | TaycaPower* BN2060 | 9 | 7.2 | 17.1 | 217 | 536 | 0.52 | 3.5 | 4340 | 114 | 10 | 54 |
| PR122 | TaycaPower* BN2060 | 9 | 6.9 | 17 | 186 | 419 | Control | 4.7 | 248 | 26 | 67 | 0 |

*TAYCAPOWER BN2060 from Tayca Corporation, which are branched sodium dodecyl benzene sulfonates.

The only major difference seen from the control and the surface-modified PR122 dispersion is seen in the amount of Calcium via ICP. All other dispersion properties are similar including the Delta E 2000 measurement.

In embodiments, the present disclosure uses surface-modified PR122 pigment in place of nominal Sun PR122 pigments with no other changes to the aggregation/coalescence process. Table 2 shows an abridged summary of the two surface-treated PR122 batches (103M, 104M) compared to typical nominal 20 gallon magenta ranges. Both batches were comparable to nominal batches in particle size and circularity measurements and bench tribo as well as surface XPS, particle ICP, residual surfactant, and rheological analyses.

The toners were prepared using a 10L Henschel Blender with a standard tool at 2800 rpm for 10 minutes. 3.3 pounds of materials having the percent by weight as provided herein. For manufacturing quantities, a 1200L Henschel Blender with a standard tool at 865 rpm for 10 minutes was used.

TABLE 2

| Specification | Nominal | 103M | 104M |
|---|---|---|---|
| Date | — | Jun. 13, 2011 | Jun. 20, 2011 |
| Wax | IGI | IGI | Cytech |
| PR122 | Sun | DNS 11TW3575 | DNS 11TW3575 |
| D50 | 5.54-5.95 | 5.55 | 5.53 |
| ND50/16 | 1.251-1.280 | 1.227 | 1.248 |
| VD84/50 | 1.181-1.209 | 1.184 | 1.212 |
| Circularity | 0.967-0.980 | 0.976 | 0.973 |
| DP Bz Tribo | 57-73 | 57.29 | 60.73 |
| DP Bz AT | 600-800 | 651 | 693 |
| Toner Az Tribo | 30-33 | 38.39 | 38.25 |
| Toner Bz Tribo | 48-53 | 47.33 | 48.87 |
| Toner Jz Tribo | 56-60 | 60.37 | 60.99 |
| % Na | 0.30-0.40 | 0.32 | 0.4 |
| ICP Al | 40-80 | 68 | n/a |
| ICP Na | 900-1200 | — | 749 |
| ICP Sn | 300-600 | — | 632 |
| Tayca | 3839-4480 | 3552 | 2287 |
| Dowfax | 262-485 | 825 | 461 |
| G′ @ 10 | 14008-16904 | 2198 | 6207 |
| Radians/sec (Pa · s) | | | |
| G″ @ 10 | 14414-17810 | 3489 | 8771.3 |
| Radians/sec (Pa · s) | | | |
| tan δ | 1.01-1.05 | 1.59 | 1.41 |
| η, Pa * s | 2010-2455 | 412 | 1074.55 |

### Example 2

Toner containing surface modified colorant of Example 1.

### Comparative Example 3

Control toner containing un-modified PR122 colorant.

The toners of Example 2 and Comparative Example 3 were blended under standard conditions and additive amounts and run alongside nominal Magenta toners (XC MA04-06 and two FX references) in the ZTP fixture. The toners were prepared by blending the toner components for 10 minutes at 2800 rpm in a 10 Liter Henschell blender.

Blend amounts for the toners of Example 2 and Comparative Example 3 are shown in Table 3.

TABLE 3

| | CEO₂ | PMMA | RX50 | RY50L | STT100H | X24 | ZNFP |
|---|---|---|---|---|---|---|---|
| Weight Percent | 0.28% | 0.5% | 0.86% | 1.29% | 0.88% | 1.73% | 0.18% |
| Amount (kilograms) | 0.63 | 1.125 | 1.935 | 2.903 | 1.98 | 3.893 | 0.405 |

CEO₂ = Cerium oxide cleaning/scrubber additive available from Tribecher or Mirek Corporation.
PMMA = cross flowed polymethyl methacrylate flow and spacer additive available from Soken Chemical.
RX50 = Fumed silica charging, admix, transfer agent available from Evonik Industries.
RY50L = Fumed silica charging, admix, transfer agent available from Evonik Industries
STT100H = Surface treated titania flow/charging agent available from Tayca Corporation.
X24 = Sol-gel silica charging, admix, transfer agent available form Shin-Etsu Chemical Co., Ltd.
ZNFP = Zinc additive, lubrication, available from Nissan Oil and Fat Corporation (NOF Corporation).

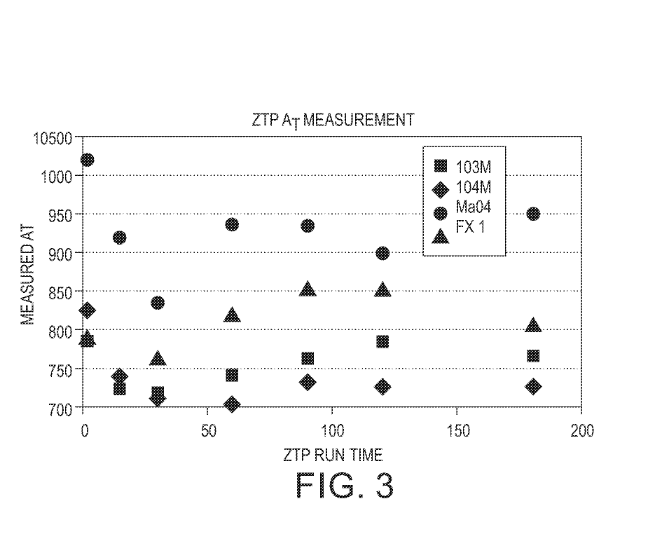

The toners of Example 2 were run alongside Comparative magenta toner of Example 3 (XC MA04-06 and two FX references) in a Xerox® 700 digital Color Press and allowed to run in the machine. FIG. 3 shows AT versus ZTP run time for samples of toners of the present disclosure comprising Example 2 [103M, 104M, FX1] and the comparative toner of Example 3 [Ma04]

FIG. 3 shows the AT of each toner throughout the ZTP run. Highlighted below in FIG. 3 is the effect that the surface-treated PR122 pigment had on the overall toner aging. This effect is due to the harsh development housing mixing that embeds the additives into the particle, continually reducing their effectiveness, with the particle charge showing larger and larger contributions during the housing run time. This phenomenon is also amplified during J zone (70F/10% RH), which occurs very often in XC and XE areas during wintertime conditions. At toner ages of 60 minutes and longer, the toners made with surface-modified PR122 demonstrated significantly improved AT over the other toners (approximately 150 units lower), thereby showing better toner aging characteristics. The decrease in AT at these high toner ages will give an improvement to the color stability and other IQ metrics compared to the untreated PR122 pigment.

Emulsion aggregation toners are known to exhibit an increase in tribo electric charge upon aging in the machine. Such increase can result in the overall loss of development as well as an increase in color instability. This increase in tribo electric charge through toner aging is believed to be primarily due to that big difference between the parent particle of toner and final toner with additives blended onto the parent particle surface. During the time that this high toner aging is occurring (for example, running at less than 3% area coverage for an extended period of time), the toner is churning in the development housing, the additives on the surface of the toner can be pounded and embedded into the surface of toner particle causing particle surface exposures and hence the increase in overall tribo electric charge.

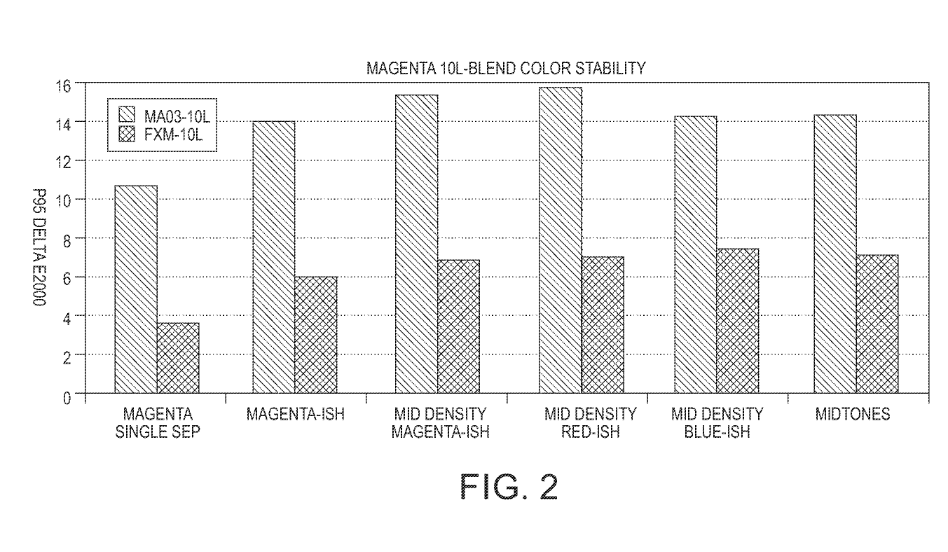

The toners of Example 2 and Comparative Example 3 were treated/aged. For each bar pair in FIG. 2, the left bar of the pair is the Comparative Example 3 measurement and the right bar of the pair is the Example 2 measurement. FIG. 2 shows that the overall A_{T} is lower for the toner of Example 2 than for Comparative Example 3 where the higher the A_{T} during higher toner age, the greater the overall color instability has been seen. This difference of 200 A_{T} units has shown to force the machine to go into a digital correct mode that stresses the overall system. This is why controlling the overall A_{T} on the parent particle is required.

Highlighted in FIG. 3 is the effect that the surface-treated PR122 pigment had on the overall toner aging. This effect is due to the harsh development housing mixing that embeds the additives into the particle, continually reducing their effectiveness, with the particle charge showing larger and larger contributions during the housing run time. This phenomenon is also amplified during J zone (70F/10% RH), which occurs very often in XC and XE areas during wintertime conditions. At toner ages of 60 minutes and longer, the toners made with surface-modified PR122 demonstrated significantly improved AT over the other toners (approximately 150 units lower), thereby showing better toner aging characteristics. The decrease in AT at these high toner ages will give an improvement to the color stability and other IQ metrics compared to the untreated PR122 pigment.

In embodiments, the toner herein comprising surface modified colorant has lower and more stable tribo electric charging characteristics, particularly with respect to high toner ages. For example, toner comprising surface modified colorant herein has a tribo electric charge of 53 μC/g or AT of 750 after 3 hours as compared to Ma04 [Comparative Example 3] which has a tribo electric charge of 68 μC/g or AT of 950 after 3 hours hours/days.

In embodiments, the toner herein comprising surface modified colorant has a higher calcium content than MA04 [Comparative Example]. Higher calcium content is advantageous because the reduction of the increase in Tribo gives a more robust performance across a range of noises for image quality (Solid Area Density, color control and consistency) including area coverage, length of running, running conditions (humidity/temperature).

In embodiments, the toner of the present disclosure exhibits lower machine tribo and improved image quality across a range of temperature/humidity conditions and toner ages as compared to prior toner.

In embodiments, the toner of the present disclosure containing the surface-modified colorant enables keeping the toner tribo more consistent and lower which provides improved image quality through reducing the delta and shift in both length of running and the overall shift in zones (RH/Temp) which further provides the ability to keep color stability/control and solid area density to meet customer needs.

The desired range for toner tribo will change based on the environment, toner composition and amount, machine, among other factors. For a charging environment of 70° F. and 10 percent relative humidity, assuming 8 percent toner concentration, in certain embodiments, the toner herein provides a consistent machine tribo measurement of from about—54 μC/g to about 70 μC/g tribo (650 AT to 850), or from about 41 to about 87.5 μC/g (5000 AT to 1050) or from about 30 to about 100 μC/g (350 AT to 1200).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A toner comprising:
a resin;
an optional wax; and
a colorant;
wherein the colorant has disposed thereon a reactive component having at least one cross-linkable carbon-carbon double bond; and
wherein the tribo electric charge of the toner is adjusted through surface treatment of the colorant with the reactive component.

2. The toner of claim 1, wherein the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof.

3. The toner of claim 1, wherein the reactive component disposed on the colorant is bisphenol A glycerolate diacrylate.

4. The toner of claim 1, wherein the resin is polyester.

5. The toner of claim 1, wherein the resin is an amorphous polyester, a crystalline polyester, or a mixture thereof.

6. The toner of claim 1, wherein the resin is selected from the group consisting of styrenes, acrylates, methacrylates, butadienes, isoprenes, acrylic acids, methacrylic acids, acrylonitriles, and combinations thereof.

7. The toner of claim 1, wherein the resin is selected from the group consisting of poly(styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylateisoprene), poly(methyl acrylate-isoprene), poly(ethyl acrylate-isoprene), poly(propyl acrylate-isoprene), poly(butyl acrylate-isoprene), poly(styrene-butylacrylate), poly(styrene-butadiene), poly(styrene-isoprene), poly(styrene-butyl methacrylate), poly(styrene-butyl acrylate-acrylic acid), poly(styrene-butadiene-acrylic acid), poly(styrene-isoprene-acrylic acid), poly(styrene-butyl methacrylate-acrylic acid), poly(butyl methacrylate-butyl acrylate), poly(butyl methacrylate-acrylic acid), poly(styrene-butyl acrylate-acrylonitrile-acrylic acid), poly(acrylonitrile-butyl acrylate-acrylic acid), and combinations thereof.

8. The toner of claim 1, wherein the colorant is selected from the group consisting of dyes, pigments, combinations of dyes, combinations of pigments, and combinations of dyes and pigments.

9. The toner of claim 1, wherein the colorant is a magenta pigment selected from the group consisting of Pigment Red 122, Pigment Red 185, Pigment Red 192, Pigment 202, Pigment Red 206, Pigment Red 235, Pigment Red 269, and combinations thereof.

10. The toner of claim 1, wherein the colorant is a magenta pigment selected from the group consisting of Pigment Red 122, Pigment Red 185, Pigment Red 192, Pigment 202, Pigment Red 206, Pigment Red 235, Pigment Red 269, and combinations thereof; and
wherein the reactive component disposed on the colorant is bisphenol A glycerolate diacrylate.

11. The toner of claim 1, wherein the wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, and combinations thereof.

12. A toner process comprising:
contacting a latex polymer; an optional wax; and a colorant to form a blend;
wherein the colorant has disposed thereon a reactive component having at least one cross-linkable carbon-carbon double bond;
adjusting the tribo electric charge of the toner through surface treatment of the colorant with the reactive component;
heating the blend at a temperature below the glass transition temperature of the latex polymer to form aggregated toner particles;
adding a coalescing agent to the toner particles thereby coalescing the toner particles; and
recovering the toner particles.

13. The toner process of claim 12, wherein the colorant is selected from the group consisting of dyes, pigments, combinations of dyes, combinations of pigments, and combinations of dyes and pigments; and
wherein the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof.

14. The toner process of claim 12, wherein the colorant is a magenta pigment selected from the group consisting of Pigment Red 122, Pigment Red 185, Pigment Red 192, Pigment 202, Pigment Red 206, Pigment Red 235, Pigment Red 269, and combinations thereof.

15. The toner process of claim 12, further comprising:
adding a second latex polymer to the aggregated toner particles to form a shell over the aggregated toner particles thereby forming a core-shell toner;
adding the coalescing agent to the toner particles, and subsequently heating the core-shell toner with the coalescing agent at a temperature above the glass transition temperature of the second latex polymer.

16. A colorant having disposed thereon a reactive component having at least one cross-linkable carbon-carbon double bond, wherein the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof.

17. The colorant of claim 16, wherein the colorant is a magenta pigment selected from the group consisting of Pigment Red 122, Pigment Red 185, Pigment Red 192, Pigment 202, Pigment Red 206, Pigment Red 235, Pigment Red 269, and combinations thereof.

18. A colorant process comprising:
providing a colorant;
disposing a reactive component having at least one cross-linkable carbon-carbon double bond on the colorant;
optionally, stifling; and
treating to effect cross-linking of the reactive component.

19. The colorant process of claim 18, wherein treating to effect cross-linking of the reactive component comprises irradiating with visible light, irradiating with ultra-violet light, heating, or a combination thereof.

20. The colorant process of claim 18, wherein the reactive component disposed on the colorant is selected from the group consisting of methyl acrylate, ethyl acrylate, butyl acrylate, 2-ethylhexyl acrylate, methyl methacrylate, ethyl methacrylate, butyl methacrylate, cyclohexyl methacrylate, stearyl methacrylate, acrylic acid, methacrylic acid, maleic acid, hydroxyethyl methacrylate, hydroxypropyl acrylate, glycidyl acrylate, alkoxymethylol acrylamide, styrene, vinyl toluene, methylstyrene, acrylonitrile, methacrylonitrile, bisphenol A glycerolate diacrylate, and mixtures and combinations thereof; and
wherein the colorant is a magenta pigment selected from the group consisting of Pigment Red 122, Pigment Red 185, Pigment Red 192, Pigment 202, Pigment Red 206, Pigment Red 235, Pigment Red 269, and combinations thereof.
